(19) United States
(12) Patent Application Publication
(10) Pub. No.: US 2025/0317796 A1
(43) Pub. Date: Oct. 9, 2025

(54) MAC-CE BASED PACKET STATUS REPORT

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US)

(21) Appl. No.: 18/628,458

(22) Filed: Apr. 5, 2024

(51) Int. Cl. H04W 28/06; H04W 28/24; H04W 80/02

(52) U.S. Cl. CPC H04W 28/06; H04W 28/24; H04W 80/02

(57) ABSTRACT

Certain aspects of the present disclosure provide a method for wireless communications at a first wireless node, generally including generating an element with information identifying a first set of one or more discarded protocol data units (PDUs) associated with a first protocol layer and outputting the element for transmission via a PDU associated with a second protocol layer.

### FIELD OF THE DISCLOSURE

Aspects of the present disclosure relate to wireless communications, and more particularly, to techniques for efficiently reporting packet status.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a first wireless node. The method includes generating an element with information identifying a first set of one or more discarded protocol data units (PDUs) associated with a first protocol layer; and outputting the element for transmission via a PDU associated with a second protocol layer.

Another aspect provides a method for wireless communications at a second wireless node. The method includes obtaining an element, via a protocol data unit (PDU) associated with a second protocol layer, with information identifying a first set of one or more discarded protocol data units (PDUs) associated with a first protocol layer; obtaining a second set of one or more PDUs associated the first protocol layer; and processing the second set of PDUs by using the information obtained in the element.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example functional split for a disaggregated base station architecture.

FIG. 6 depicts an example scenario where aspects of the present disclosure may be utilized.

FIGS. 7A and 7B depict an example traffic flow that may be processed in accordance with aspects of the present disclosure.

FIG. 8 depicts an example call flow for a PDCP based status report indicating missing SNs.

FIG. 9 depicts an example call flow for a PDCP based status report indicating missing SNs.

FIG. 10 depicts a method for wireless communications.

FIG. 11 depicts a method for wireless communications.

FIG. 12 depicts aspects of an example communications device.

### DETAILED DESCRIPTION

5G new radio (NR) provides a high-speed, low-latency and high-reliability wireless connectivity which can enable immersive virtual reality (VR), augmented reality (AR), mixed reality (MR), and extended reality (XR, which can be a variant of VR, AR, and/or MR) multimedia and cloud computing services. XR/multimedia data services may involve various user interface (UI) devices, such as AR Glasses and VR Head-Mounted Displays (HMDs) used in Cloud-based Gaming and Cloud-based artificial intelligence (AI). These advanced multimedia applications may have strict system requirements. Requirements include high data rate and low latency to better allow a targeted 99% of XR traffic to be delivered within a packet delay budget (PDB) (e.g., 10 ms), and low power consumption to better save power on multimedia devices (e.g., less than 1 W for AR glasses/headsets).

XR applications often consume data in relatively large units, referred to as protocol data unit (PDU) sets that represent a set of Internet Protocol (IP) packets, rather than single IP packets. In both uplink and downlink, certain features may rely on the notions of PDU Set and Data Burst. PDU sets and Data Bursts generally enable a radio access network (RAN) to identify the PDUs which carry content that the application processes as a single unit (e.g., an application data unit/ADU that represents a portion of an image, an audio frame) and the duration of a data transmission, respectively. A Data Burst may include different PDU sets that should be delivered to a user equipment (UE) with the same deadline (e.g., all slices of a video frame).

Applications typically specify transport layer requirements on a PDU Set (e.g., on “slices” of video frames). For example, an application may specify that PDU sets should be delivered within a certain timeframe. Similar to a PDB for individual packets, this timeframe for PDU sets may be referred to as a PDU set delay budget (PSDB).

As XR traffic, which can be a variant of VR or AR or MR, is very time sensitive as well as packet loss sensitive from user experience perspective, there are good number of measures to ensure the successful delivery of ADU/PDUSet with in the stipulated time limits to meet the Jitter requirements governed as part of the PSDB (PDU Set Delay Budget) and error metric PSER (PDU Set Error Rate) along with importance based on a PDU Set Integrated Handling Indication (PSIHI).

A PDU Set may have some level of forward error correction (FEC) information to correct some of the missing bits. While this ADU/PDU Set is transmitted over the Radio network (e.g., 5G NR), it will go through various radio protocols (layers) to ensure successful delivery. This includes Packetization (packet data convergence protocol-PDCP), Segmentation (radio link control-RLC), Retransmission (RLC) and Redundancy (e.g., hybrid automatic repeat request-HARQ) based Phy layer transmission.

Typically, one ADU packet is divided into N PDCP Packets, represented as a PDU Set and transmitted over the Air (OTA). A maximum value of a PDCP packet size is typically fixed in the radio interface based on Maximum Transfer Unit (MTU) settings exchanged over the Cellular signaling messages (e.g., for a PDU Session) between NW and UE.

Even with all the Radio redundancy (ARQ and HARQ) protocols, packets might be lost in the OTA interface or might get delayed beyond the timing requirements (e.g., based on a reordering timer, T_{reordering}) in PDCP, ultimately impacting either PSDB delay budget or PSER error rate KPI.

Packets may be lost for various reasons. For example, the packet loss at the PDCP layer can be due to a genuine RLC level packet loss (e.g., in an RLC unacknowledged mode-UM), due to delayed scheduling/retransmissions (e.g., in an RLC acknowledged mode-AM), or when transmitter discards the packets after PDCP SN assignment (e.g., due to expiration of a discard timer).

In some cases, a receiver may be notified of packets discarded at the transmitter via a PDCP control PDU. Unfortunately, a PDCP Control PDU based indicating may be relatively show, for example, as it might be behind the queue in the transmission path (depending on SW implementation and buffer management).

Aspects of the present disclosure, however, provide a more efficient signaling mechanism for indicating discarded packets. For example, according to certain aspects, lower layer signaling may be used to provide the indication, such as a medium access control (MAC) control element (CE). Such lower layer signaling may avoid the delay in scheduling and packet loss (discard) that PDCP PDUs may suffer.

Therefore, one potential advantage of the mechanisms proposed herein is a reduction in latency of indicating missing packets. As a result, processing latency at the receiver side may be reduced as the receiver may be able to process packets received in-sequence packets received after the discarded packets, without having to wait for a retransmission timer to expire.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

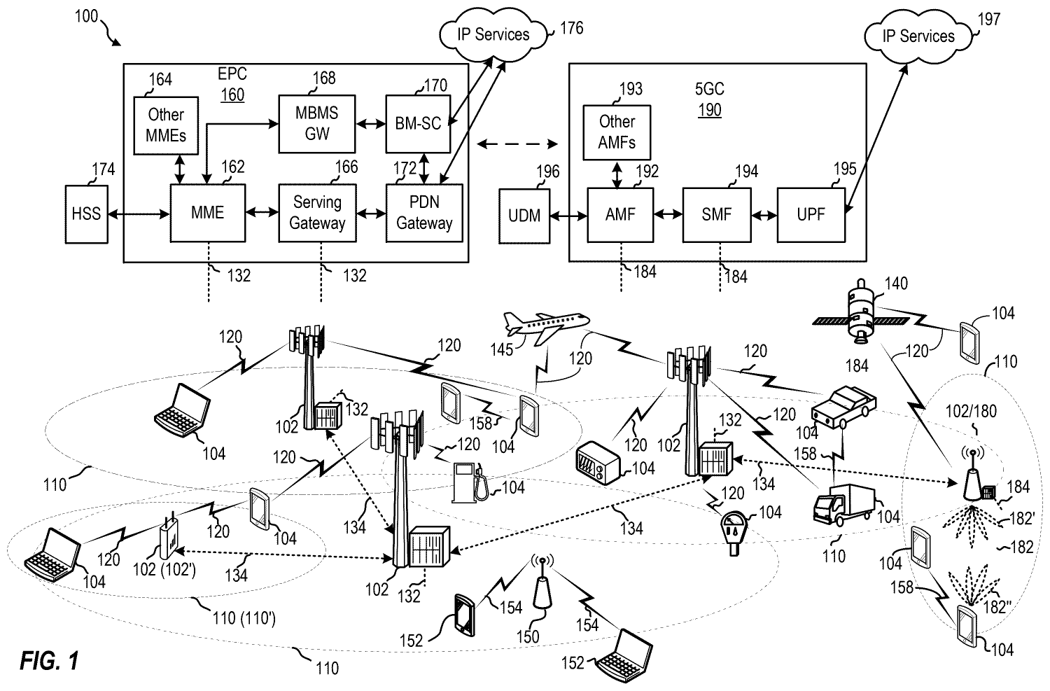

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

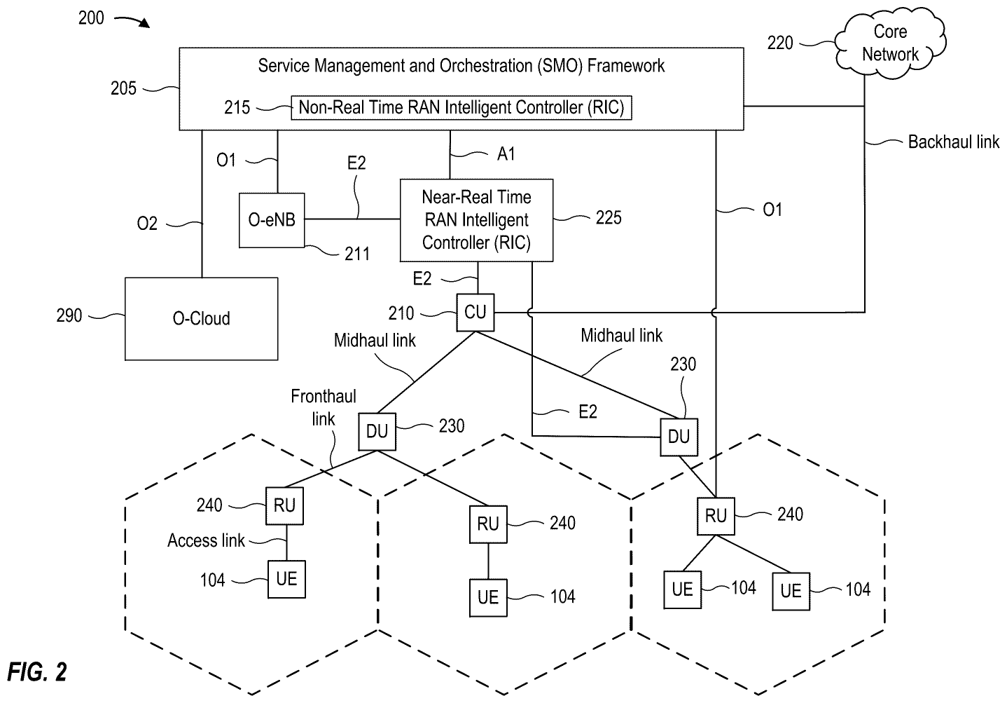

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

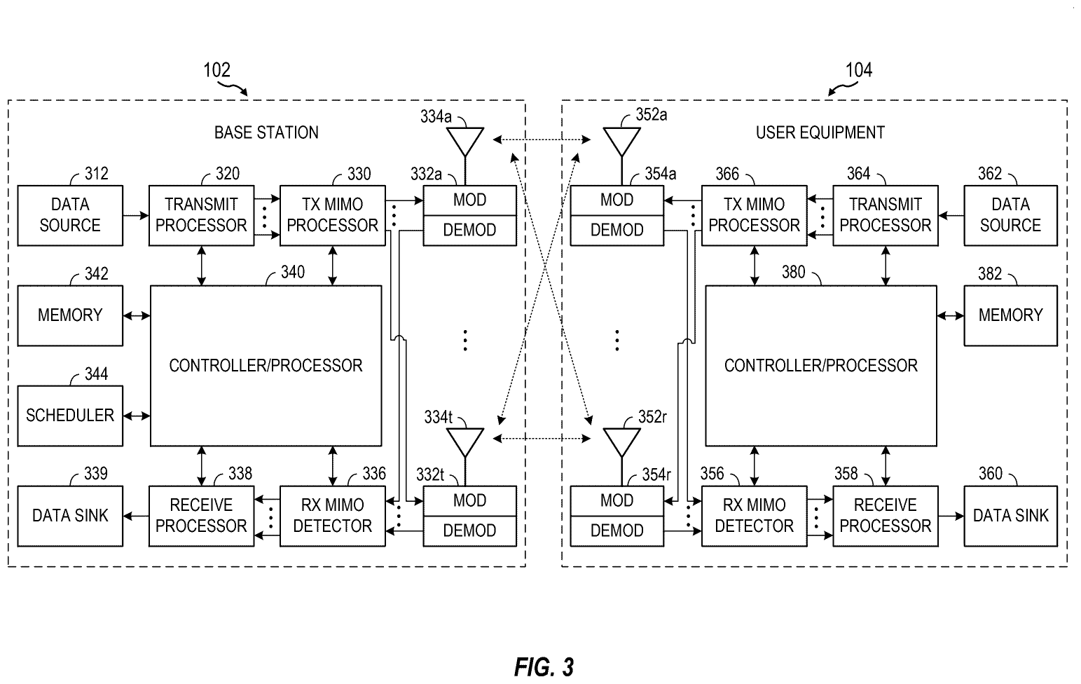

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

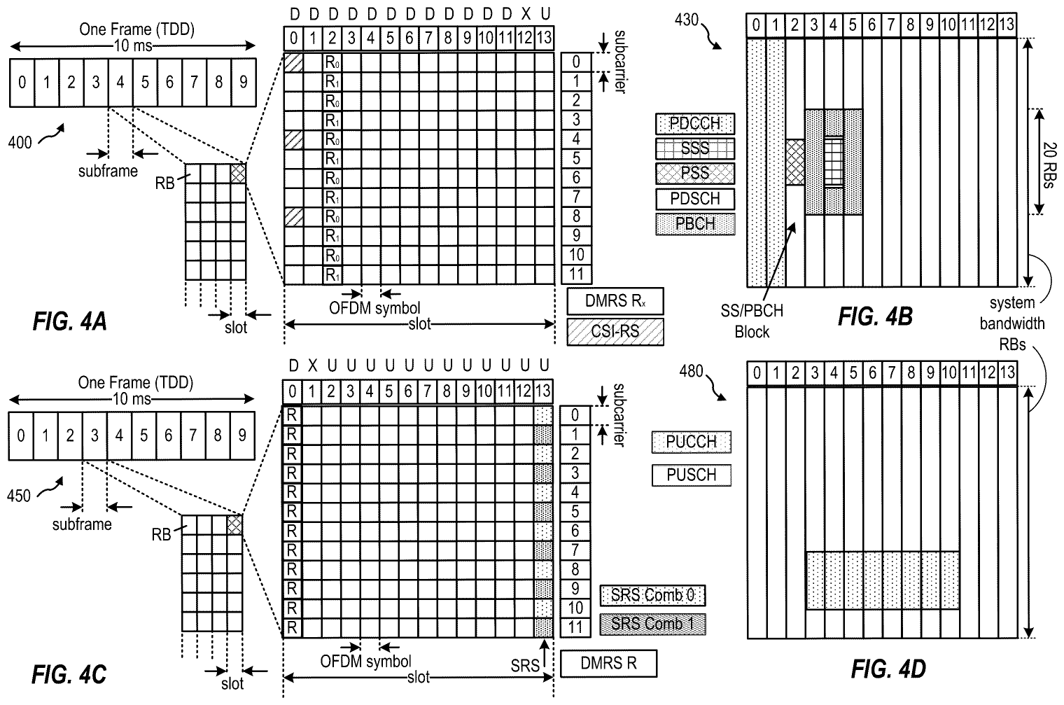

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Functional Split

As described above with reference to FIG. 2, O-RAN provides a standardized architecture and set of interfaces between components that form a disaggregated base station.

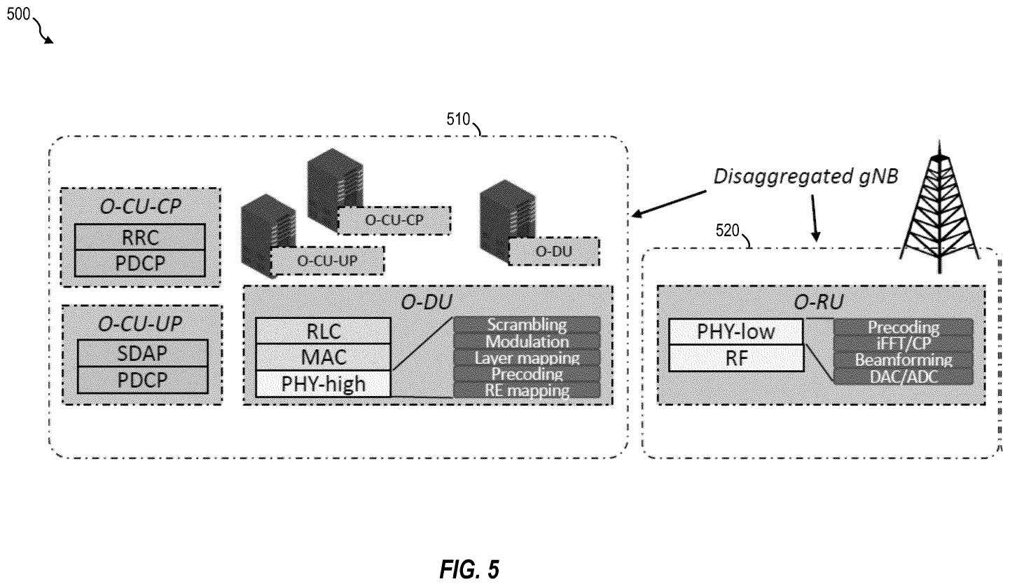

As illustrated in diagram 500 of FIG. 5, O-RAN has enabled a transition from conventional (co-located/self-contained) base stations to a virtualized gNB with a functional split. As shown, a CU and DU may be located at one site/location 510 (e.g., the edge), while the RU may be located at another site/location 520 (e.g., a cell site).

The figure illustrates an example of a functional split that may be referred to as a 7.2× split in 3GPP. The illustrated functional split distributes the higher layers of the stack in the CU, such as RRC, PDCP, and SDAP. On the other hand, the DU may features lower layers, such as the RLC, MAC, and part of the physical layer (PHY). This example split determines features frequency-domain functionalities in the DU (e.g., modulation, layer mapping, precoding, and PRB mapping), and the time-domain functionalities in the RU, such as precoding, Fast Fourier Transform (FFT), Cyclic Prefix (CP) addition/removal, beamforming, and Radio Frequency (RF) components

### Overview of ADUs/PDU Sets

As noted above, 5G new radio (NR) provides a high-speed, low-latency and high-reliability wireless connectivity which can enable immersive virtual reality (VR), augmented reality (AR) and extended reality (XR) multimedia and cloud computing services. XR/multimedia data services may involve various user interface (UI) devices.

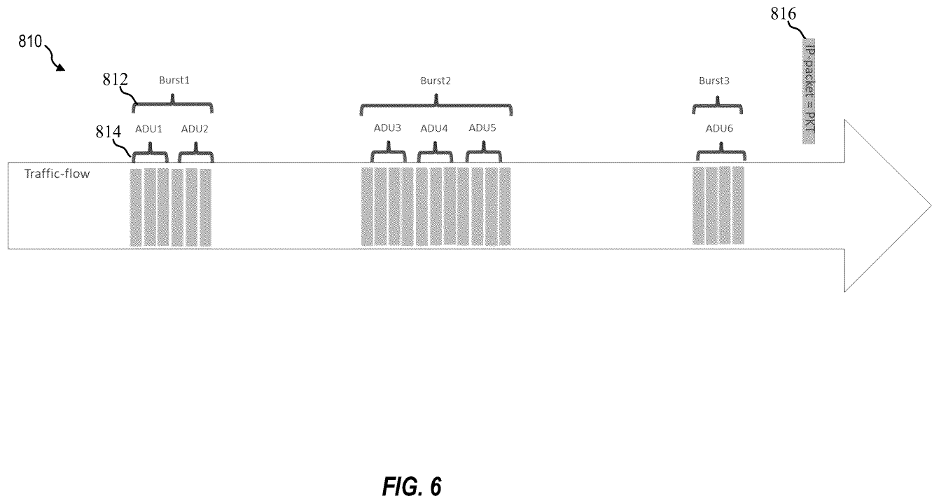

For example, diagram 600 of FIG. 6 depicts a scenario where a UE, such as an XR headset, AR Glasses and VR Head-Mounted Displays (HMDs) is used to communicate with an edge cloud 610 for Cloud-based Gaming and Cloud-based artificial intelligence (AI).

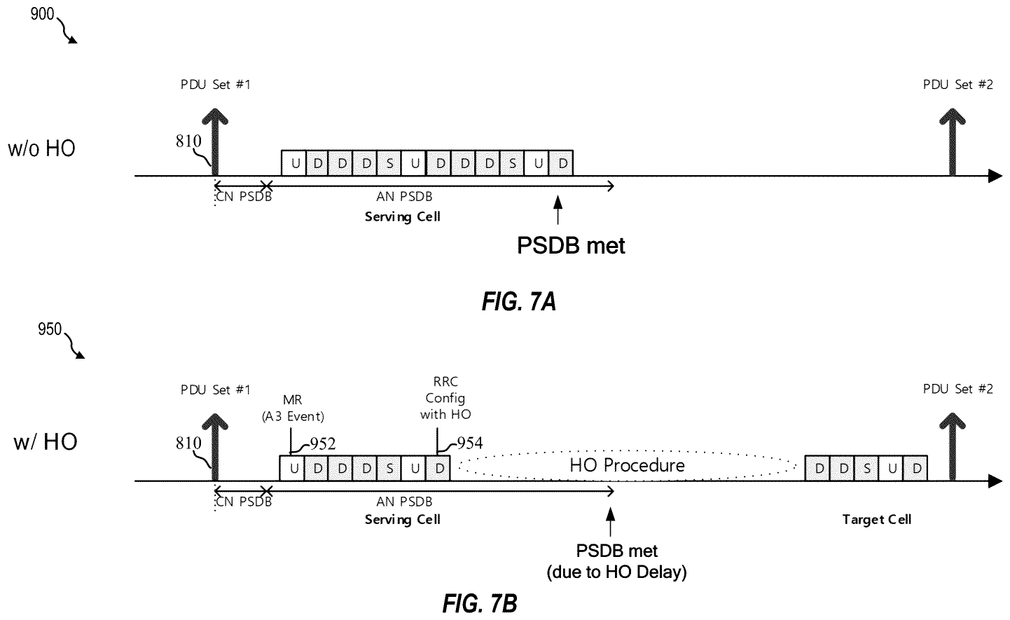

As illustrated in FIG. 7, a traffic flow 710 of XR applications may include bursts 712 of protocol data unit (PDU) sets 714, which may also be referred to as an application data unit (ADU). Each PDU set may represent a set of Internet Protocol (IP) packets 816 that represents a unit of information at an application layer, such as one video frame per burst or “slices” of a video frame per burst. A burst 712 generally refers to a set of PDU sets 714 that include IP packets 716 that should be delivered to a user equipment (UE) with the same deadline (e.g., all slices of a video frame).

XR applications often consume data in relatively large units, referred to as protocol data unit (PDU) sets that represent a set of Internet Protocol (IP) packets, rather than single IP packets. In both uplink and downlink, certain features may rely on the notions of PDU Set and Data Burst. PDU sets and Data Bursts generally enable a radio access network (RAN) to identify the PDUs which carry content that the application processes as a single unit (e.g., an application data unit/ADU that represents a portion of an image, an audio frame) and the duration of a data transmission, respectively. A Data Burst may include different PDU sets that should be delivered to a user equipment (UE) with the same deadline (e.g., all slices of a video frame).

As noted above, applications may specify transport layer requirements on a PDU Set, for example, that PDU sets should be delivered within a certain timeframe, referred to as a PDU set delay budget (PSDB).

### Aspects Related to MAC CE based PDCP Status Report

Aspects of the present disclosure relate to wireless communications, and more particularly, to techniques for efficiently reporting packet status.

As noted above, one ADU packet is typically divided into N PDCP Packets, represented as a PDU Set and transmitted over the Air (OTA). Even with all the Radio redundancy (ARQ and HARQ) protocols, packets might be lost in the OTA interface or might get delayed beyond the timing requirements (e.g., based on a reordering timer, T_{reordering}) in PDCP, ultimately impacting either PSDB delay budget or PSER error rate KPI.

Traffic for XR applications are commonly mapped on RLC unacknowledged mode (RLC-UM where acknowledgements are not used/expected) in order to avoid excessive retransmission delays at RLC layers. RLC-UM relies solely on MAC HARQ level reliability, by adjusting the coding rate as well as MCS to give more protection at the PHY level. Any usage of the RLC AM (for XR traffic) presents a potential latency issue with the possibility of higher number of RLC retransmissions gating the remaining packets received waiting for in-sequence delivery.

The discarding of packets at the transmitter can have implications at the receiver RLC/PDCP entity. These implications relate to PDCP level packet loss and PDCP window movement (e.g., based on a reordering timer, T_{reordering}, expiration), and may not be readily apparent at transmitting RLC/PDCP entity.

Any packet loss related issues will impact the application layer and may cause an application to adjust application layer FEC and/or change a coding rate. This may compromise application quality, for example, when subject to dynamic radio conditions like fast fading or cell loading or interference variations.

Though a network (e.g., gNB) may know a number of HARQ failures, that information does not provide a fine granularity, in terms of which RLC/PDCP packets are part of that failed HARQ. It is expensive (e.g., in processing terms) to track failures from MAC HARQ, to RLC SN, to PDCP SN.

As noted above, in typical functional splits, PDCP functionality is part of the CU and RLC is part of the DU in deployment architecture. This becomes even more challenging with certain disaggregated RAN mechanisms (e.g., multi-vendor DU-CU models) and possible packet losses and reordering of packets between PDCP and RLC entities over Xn-U interface with GTP-U based IP/UDP transport mechanism. Packet loss and mapping of RLC/PDCP SN on the transmit (e.g., network) side may cause various implementation issues.

Providing information regarding missing PDCP SNs to a receiver may be beneficial. For example, this information may allow a receiver to avoid starting a reordering timer (T_{reordering}) and the associated delay an active reordering time has on remaining packets. This is particularly impactful if the missing packets are discarded at the transmitter-side and are not going to be recovered at all. Without this information, the receiver may be limited to only start the timer for the packets which are getting recovered at MAC HARQ level or through RLC ARQ level only.

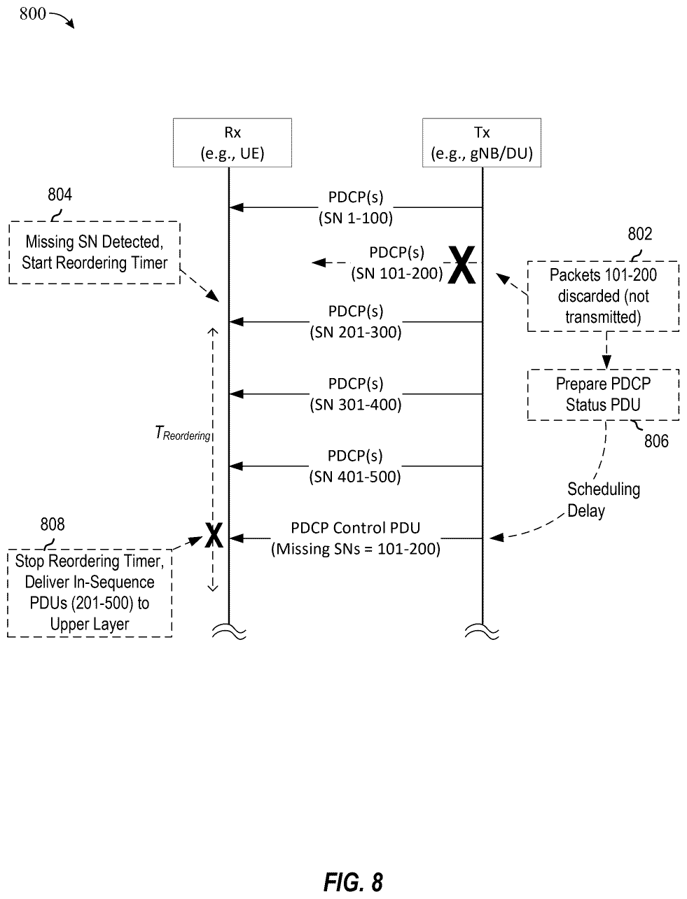

In some cases, a transmitter may provide information regarding missing/lost PDCP SNs, from transmitter perspective, via a PDCP Status report. FIG. 8 depicts a call flow diagram 800 for an example where a transmitting PDCP entity (e.g., a gNB or DU) may use a PDCP Status report to provide information regarding missing/lost PDCP SNs to a receiving PDCP entity (e.g., a UE). In other examples, a UE may be the transmitter (e.g., of uplink traffic) and a gNB may be the receiver.

The example illustrated in FIG. 8 assumes attempted deliver of PDCP packets with SN 1 to 500. For example, at a CU, the PDCP layer may prepare the packets 1 to 500 and provide the packets from the CU user plane (CU-UP) to the DU over Xn interface. As illustrated, PDCP packets 1 to 100 may be transmitted (e.g., at/by the DU).

As indicated at 802, PDCP packets 101-200 are discarded. For example, while waiting for DL Scheduling, a DU may discard PDCP packets 101-200 for one of various reasons. For example, such reasons may include expiration of a discard timer, due to PSIHI information (e.g., indicating not all packets are needed) and a required number of packets already successfully completed RLC transmission, and/or due to FEC information from upper layers or application level knowledge.

As indicated at 804, the receiver may detect that PDCP SNs 101-200 are missing, after receiving PDCP SNs 201-300 (out of sequence) and start a reordering timer (T_{reordering}). As indicated, the discarding of PDCP SNs 101-200 will result in a delay in processing subsequent packets that are successfully received, while waiting for Treordering to expire, resulting in delayed packets delivery for the sub-sequent packets which are successfully received.

As indicated at 806, a PDCP status PDU may be prepared (to indicate the missing PDCP SNs 101-200. However, there may be some delay in delivery of the PDCP status PDU.

For example, in some cases, a DU may inform the CU about discarded packets (e.g., of PDCP SNs 101-200), in order for the CU to prepare the PDCP Status PDU, as the PDCP entity is logically present in CU. The CU may prepare the PDCP status PDU and provide it to the DU for transmission.

One component of delay is because this generation of the PDCP status PDU may result in both CU-to-DU and DU-to-CU interactions. An additional amount of delay may be incurred while the PDCP Status PDU will be sitting behind other PDCP SNs in the queue at the DU. For example, in the illustrated example, the PDCP status PDU is behind PDCP SN 500 waiting for transmission.

Therefore, at the UE, PDCP SNs 201-500 are received before the PDCP Control PDU. Because the reordering timer is still running, however, these packets are held, even though they are received in-sequence.

As indicated at 808, once the PDCP Control PDU is received, the receiver may learn that PDCP SNs 101-200 are discarded. Thus, the receiver may finally deliver the in-sequence PDCP SNs 201-500 to an upper layer for further processing.

As illustrated by this example, even though a DU may be sending PDCP packets in-order from a CU perspective, the PDCP Control PDU may need to wait (e.g., until after delivery of PDCP SNs 401-500) to get a transmission opportunity, despite the UE receiving packets SN 201-300 (and learning of the missing PDCP SNs 101-200) much earlier.

Thus, while the PDCP control PDU clearly notifies the receiver of the discarded PDCP packets (SNs 101-200), this approach adds significant delay (from receiving PDCP SN201 to receiving the PDCP Control PDU).

This delay may be significant based on various reasons. For example, the original number of packets at the DU may be relatively large, due to large buffer sizes (e.g., with 2000 packets or more waiting). As another example, if the NW RRM based scheduling is slow, original packets may be getting drained slowly, again resulting in the PDCP Control PDU to wait a long time for transmission opportunity. As still another example, the UE may be going through marginal radio conditions, resulting in a reduced CSI metric causing less scheduling.

Aspects of the present disclosure provide a more efficient signaling mechanism for indicating discarded packets, however, that may avoid such delay. For example, the mechanisms proposed herein may allow information regarding discarded PDCP PDUs to be sent from the DU itself, as the DU is aware of exactly what PDCP PDUs are discarded due to any of the reasons noted above.

According to certain aspects, lower layer signaling may be used to provide the indication, such as a medium access control (MAC) control element (CE). Such lower layer signaling may avoid the delay in scheduling and packet loss (discard) that PDCP PDUs may suffer. Providing information regarding missing/discarded PDCP packets through a MAC-CE from the transmitter may enable the receiver to achieve better receiver window management. This may help improve the PSDB/PSER aspects of traffic, such as XR applications that attempt to provide an immersive XR experience along with multi-modal traffic.

In some cases, the information regarding discarded PDCP PDUs may be provided in a new PDCP Status report via MAC-CE. For example, a new “PDCP Status” MAC-CE type may indicate the packet loss as information only during data plane activity from a transmitter to receiver. In some cases, this new PDCP Status report may have a new format indicating the “Missing SN information.” For example, this information may be provided with a first SN and a bitmap and/or a list) indicating a number of subsequent SNs which are not transmitted.

Referring to the example shown in FIG. 8, because the PDCP SN 101-200 are discarded and known to the transmitter, the transmitter can send a MAC-CE with this missing PDCP SN information (101-200) as part of the MAC-TB before sending PDCP SN 201 (or along with PDCP SN 201). The receiver, (before or) while receiving the PDCP SN 201, also receives information indicating PDCP SNs 101-200 are missing, which may help to deliver SN 201 (and subsequent SNs) without any additional latency.

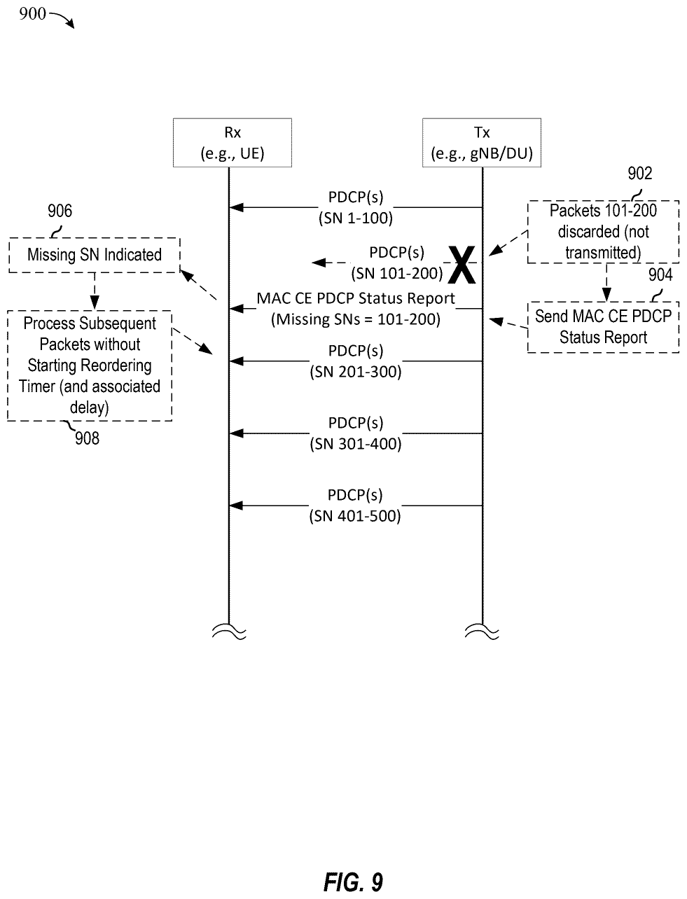

The concept of providing information regarding discarded PDCP PDUs via a MAC CE may be understood with reference to the call flow diagram 900 of FIG. 9. As with the example shown in FIG. 8, the transmitter in FIG. 9 may be a network entity (e.g., a gNB/DU), while the receiver may be a UE. In other examples, a UE may be the transmitter (e.g., of uplink traffic) and a gNB may be the receiver.

The example illustrated in FIG. 9 again assumes attempted deliver of PDCP packets with SN 1 to 500. For example, at a CU, the PDCP layer may prepare the packets 1 to 500 and provide them, from the CU-UP, to the DU over Xn interface. As illustrated, packets 1 to 100 are transmitted (e.g., at/by the DU).

As indicated at 902, PDCP packets 101-200 are discarded (e.g., for any reasons discussed above).

As illustrated at 904, the transmitter may send a MAC CE PDCP status report indicating the missing SNs (101-200). For example, assuming the transmitter is a DU, the DU may prepare the MAC-CE with PDCP Missing SN info for SN 101-200 immediately. The DU may, thus, be ready to transmit this information in a MAC-TB, before transmitting PDCP SN 201 or, in some cases, along with PDCP SN 201 transmission.

In contrast to the PDCP PDU based report shown in FIG. 8, no additional interaction (and associated delay) between a DU and CU is needed to prepare the PDCP missing SN information in the MAC CE to be sent to a UE.

Thus, as indicated at the receiver side, after receiving the indication of the missing SNs, at 906, the receiver may process subsequent packets (e.g., SN 201-300) without starting a reordering time (and the associated delay), as indicated at 908.

In other words, without any reordering timer blocking, PDCP SNs 201-300 may be delivered to upper layers and the PDCP window lower edge may be moved in preparation of SN 301 reception.

Thus, when compared with the PDCP PDU based PDCP SN status reporting shown in FIG. 8, the MAC CE based PDCP SN status reporting may not cause additional delay at the receiver (due to reordering timer starting or waiting for scheduling of the PDCP Control PDU). Thus, the MAC CE based reporting may avoid the time delay (shown in FIG. 8) in delivering the PDCP SN 201 from the receiver perspective resulting in improved processing.

As described herein, a MAC CE based PDCP status report may result in a UE not having to hold a large number of packets in a reordering window, which might cause memory build up issues or latency issues for the already received packets. By providing this information to a receiver may avoid unnecessary PDCP window related delays for remaining packets which are already received, thereby reducing latency.

MAC CE based PDCP status reporting may provide flexibility for Infrastructure (Infra)/network to configure an RLC AM entity, without concern regarding excessive retransmissions and PDCP window management issues. In an O-RAN scenario, a DU may adapt the packet discarding based on radio conditions and RLC level acknowledgements dynamically.

A transmitter (e.g., gNB, DU or UE) may take advantage of PSIHI, as well as FEC, in PDU Set processing. The techniques proposed herein may help improve radio resource utilization at the over-the-air (OTA) level, which may help improve scheduler loading and UE power management.

Further, in O-RAN scenarios, the MAC CE based PSCP status reporting proposed herein may result in a reduced number of round trip signaling, between DU to CU and CU to DU, to inform-prepare-transmit PDCP Control PDU respectively, potentially enabling rapid adaptation and reducing latency.

### Example Operations

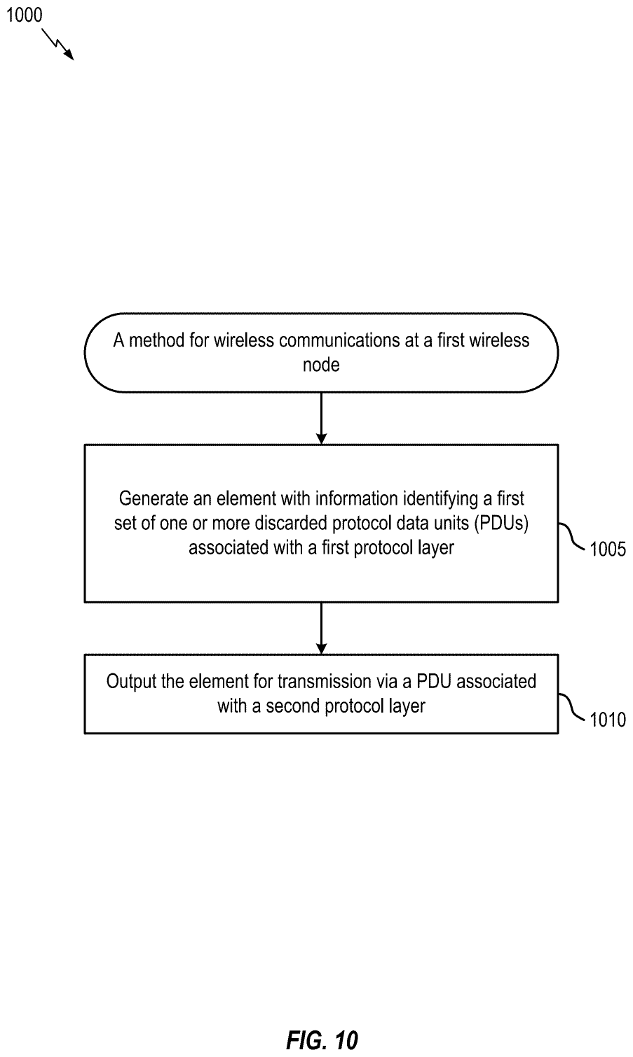

FIG. 10 shows an example of a method 1000 of wireless communications at a first wireless node. In some examples, the first wireless node is a user equipment, such as a UE 104 of FIGS. 1 and 3. In some examples, the first wireless node is a network entity, such as a BS 102 of FIGS. 1 and 3, or a disaggregated base station as discussed with respect to FIG. 2.

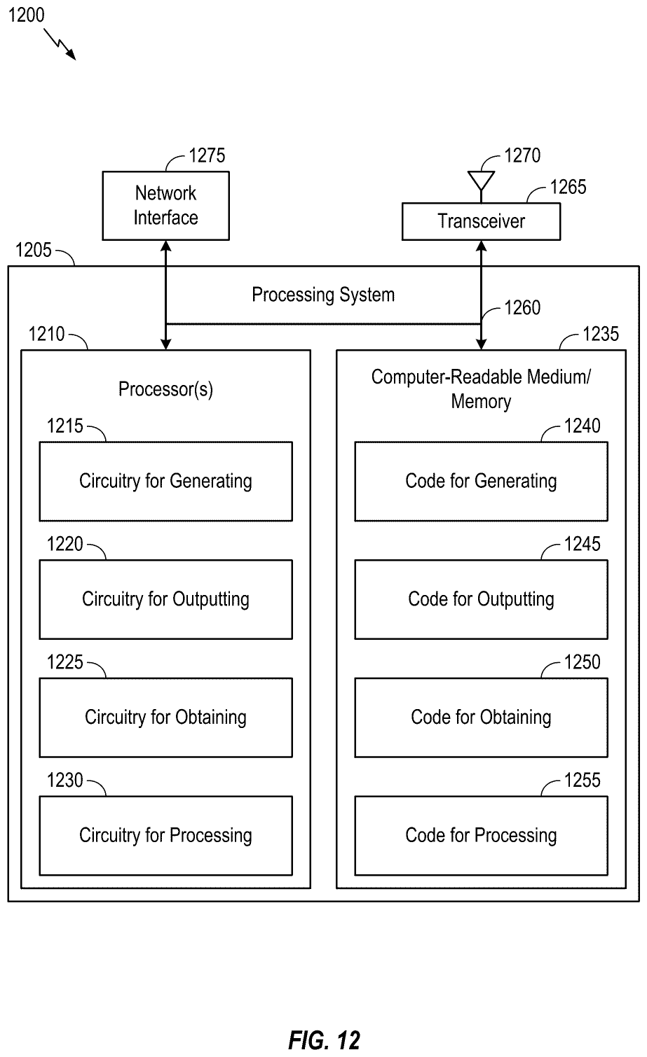

Method 1000 begins at step 1005 with generating an element with information identifying a first set of one or more discarded protocol data units (PDUs) associated with a first protocol layer. In some cases, the operations of this step refer to, or may be performed by, circuitry for generating and/or code for generating as described with reference to FIG. 12.

Method 1000 then proceeds to step 1010 with outputting the element for transmission via a PDU associated with a second protocol layer. In some cases, the operations of this step refer to, or may be performed by, circuitry for outputting and/or code for outputting as described with reference to FIG. 12.

In some aspects, at least one of: the first protocol layer comprises a packet data convergence protocol (PDCP) layer; or the second protocol layer comprises a medium access control (MAC) layer.

In some aspects, the information identifies one or more sequence numbers (SNs) of the first set of one or more discarded PDUs.

In some aspects, the information comprises a list or a bitmap that identifies one or more sequence numbers (SNs) of the first set of one or more discarded PDUs. In some aspects, the element comprises a MAC control element (CE).

In some aspects, the method 1000 further includes outputting, after outputting the MAC CE, one or more PDUs with one or more SNs higher than one or more SNs of the one or more discarded PDUs. In some cases, the operations of this step refer to, or may be performed by, circuitry for outputting and/or code for outputting as described with reference to FIG. 12.

In some aspects, the MAC CE includes a type field indicating the MAC CE conveys information that identifies one or more SNs of the one or more discarded PDUs.

In some aspects, the method 1000 further includes outputting a second set of one or more PDCP PDUs with or after outputting the MAC CE. In some cases, the operations of this step refer to, or may be performed by, circuitry for outputting and/or code for outputting as described with reference to FIG. 12.

In some aspects, the first wireless node comprises a user equipment (UE) or a network entity.

In some aspects, the method 1000 further includes outputting signaling indicating use of the element to indicate discarded PDUs is activated, when one or more conditions are met. In some cases, the operations of this step refer to, or may be performed by, circuitry for outputting and/or code for outputting as described with reference to FIG. 12.

In some aspects, the one or more conditions involve at least one of: detection of discarded PDUs; traffic congestion; or a quality of service (QOS) policy.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

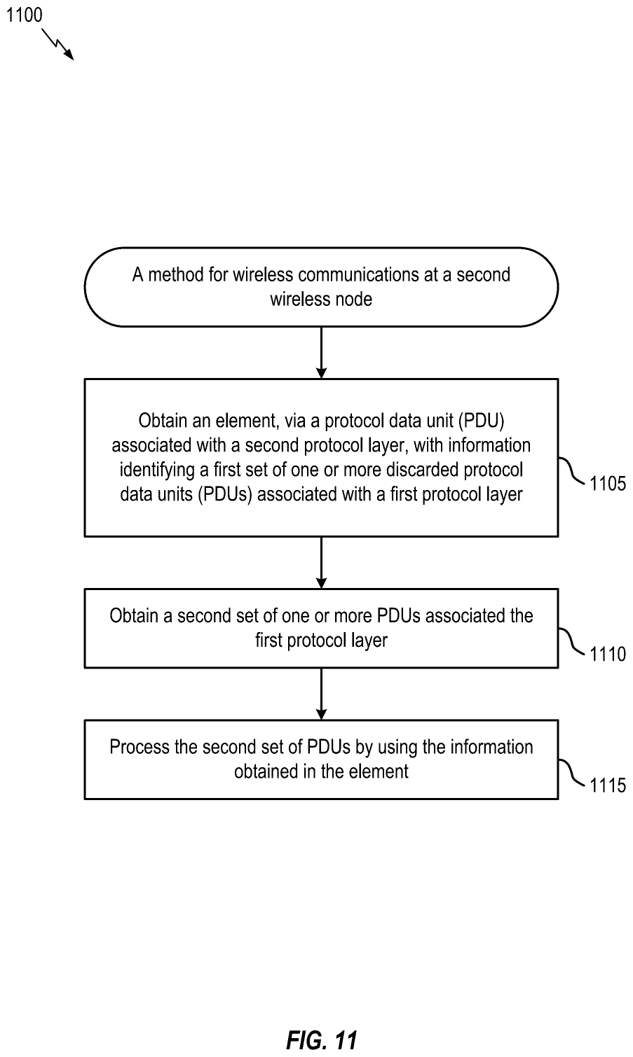

FIG. 11 shows an example of a method 1100 of wireless communications at a second wireless node. In some examples, the second wireless node is a user equipment, such as a UE 104 of FIGS. 1 and 3. In some examples, the second wireless node is a network entity, such as a BS 102 of FIGS. 1 and 3, or a disaggregated base station as discussed with respect to FIG. 2.

Method 1100 begins at step 1105 with obtaining an element, via a protocol data unit (PDU) associated with a second protocol layer, with information identifying a first set of one or more discarded protocol data units (PDUs) associated with a first protocol layer. In some cases, the operations of this step refer to, or may be performed by, circuitry for obtaining and/or code for obtaining as described with reference to FIG. 12.

Method 1100 then proceeds to step 1110 with obtaining a second set of one or more PDUs associated the first protocol layer. In some cases, the operations of this step refer to, or may be performed by, circuitry for obtaining and/or code for obtaining as described with reference to FIG. 12.

Method 1100 then proceeds to step 1115 with processing the second set of PDUs by using the information obtained in the element. In some cases, the operations of this step refer to, or may be performed by, circuitry for processing and/or code for processing as described with reference to FIG. 12.

In some aspects, at least one of: the first protocol layer comprises a packet data convergence protocol (PDCP) layer; or the second protocol layer comprises a medium access control (MAC) layer.

In some aspects, the information identifies one or more sequence numbers (SNs) of the first set of one or more discarded PDUs.

In some aspects, the information comprises a list or bitmap that identifies one or more sequence numbers (SNs) of the first set of one or more discarded PDUs.

In some aspects, the second set of PDUs have one or more sequence numbers (SNs) higher than one or more SNs of the discarded PDUs.

In some aspects, processing the second set of PDUs of the first protocol layer based on the information obtained in the element comprises: delivering the second set of PDUs to a third protocol layer independent of a reordering timer; and updating a window based on the one or more SNs of the second set of PDUs.

In some aspects, the element comprises a MAC control element (CE).

In some aspects, the MAC CE includes a type field indicating the MAC CE conveys information that identifies SNs of the one or more discarded PDUs.

In some aspects, the MAC CE is obtained with or after the second set of PDUs.

In some aspects, the second wireless node comprises a user equipment (UE) or a network entity.

In some aspects, the method 1100 further includes obtaining signaling indicating use of the element to indicate discarded PDUs is activated. In some cases, the operations of this step refer to, or may be performed by, circuitry for obtaining and/or code for obtaining as described with reference to FIG. 12.

In one aspect, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative steps are possible consistent with this disclosure.

### Example Communications Device(s)

FIG. 12 depicts aspects of an example communications device 1200. In some aspects, communications device 1200 is a user equipment, such as UE 104 described above with respect to FIGS. 1 and 3. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1265 (e.g., a transmitter and/or a receiver). In some aspects (e.g., when communications device 1200 is a network entity), processing system 1205 may be coupled to a network interface 1275 that is configured to obtain and send signals for the communications device 1200 via communication link(s), such as a backhaul link, midhaul link, and/or fronthaul link as described herein, such as with respect to FIG. 2. The transceiver 1265 is configured to transmit and receive signals for the communications device 1200 via the antenna 1270, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1235 via a bus 1260. In certain aspects, the computer-readable medium/memory 1235 is configured to store instructions (e.g., computer-executable code) that when executed by the one or more processors 1210, cause the one or more processors 1210 to perform the method 1000 described with respect to FIG. 10, or any aspect related to it; and the method 1100 described with respect to FIG. 11, or any aspect related to it. Note that reference to a processor performing a function of communications device 1200 may include one or more processors 1210 performing that function of communications device 1200.

In the depicted example, computer-readable medium/memory 1235 stores code (e.g., executable instructions), such as code for generating 1240, code for outputting 1245, code for obtaining 1250, and code for processing 1255. Processing of the code for generating 1240, code for outputting 1245, code for obtaining 1250, and code for processing 1255 may cause the communications device 1200 to perform the method 1000 described with respect to FIG. 10, or any aspect related to it; and the method 1100 described with respect to FIG. 11, or any aspect related to it.

The one or more processors 1210 include circuitry configured to implement (e.g., execute) the code stored in the computer-readable medium/memory 1235, including circuitry for generating 1215, circuitry for outputting 1220, circuitry for obtaining 1225, and circuitry for processing 1230. Processing with circuitry for generating 1215, circuitry for outputting 1220, circuitry for obtaining 1225, and circuitry for processing 1230 may cause the communications device 1200 to perform the method 1000 described with respect to FIG. 10, or any aspect related to it; and the method 1100 described with respect to FIG. 11, or any aspect related to it.

Various components of the communications device 1200 may provide means for performing the method 1000 described with respect to FIG. 10, or any aspect related to it; and the method 1100 described with respect to FIG. 11, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1265 and the antenna 1270 of the communications device 1200 in FIG. 12. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1265 and the antenna 1270 of the communications device 1200 in FIG. 12.

### Example Clauses

Implementation examples are described in the following numbered clauses:

Clause 1: A method for wireless communications at a first wireless node, comprising: generating an element with information identifying a first set of one or more discarded protocol data units (PDUs) associated with a first protocol layer; and outputting the element for transmission via a PDU associated with a second protocol layer.

Clause 2: The method of Clause 1, wherein at least one of: the first protocol layer comprises a packet data convergence protocol (PDCP) layer; or the second protocol layer comprises a medium access control (MAC) layer.

Clause 3: The method of any one of Clauses 1-2, wherein the information identifies one or more sequence numbers (SNs) of the first set of one or more discarded PDUs.

Clause 4: The method of any one of Clauses 1-3, wherein the information comprises a list or a bitmap that identifies one or more sequence numbers (SNs) of the first set of one or more discarded PDUs.

Clause 5: The method of any one of Clauses 1-4, wherein the element comprises a MAC control element (CE).

Clause 6: The method of Clause 5, further comprising outputting, after outputting the MAC CE, one or more PDUs with one or more SNs higher than one or more SNs of the one or more discarded PDUs.

Clause 7: The method of Clause 5, wherein the MAC CE includes a type field indicating the MAC CE conveys information that identifies one or more SNs of the one or more discarded PDUs.

Clause 8: The method of Clause 5, further comprising outputting a second set of one or more PDCP PDUs with or after outputting the MAC CE.

Clause 9: The method of any one of Clauses 1-8, further comprising outputting signaling indicating use of the element to indicate discarded PDUs is activated, when one or more conditions are met.

Clause 10: The method of Clause 9, wherein the one or more conditions involve at least one of: detection of discarded PDUs; traffic congestion; or a quality of service (QOS) policy.

Clause 11: A method for wireless communications at a second wireless node, comprising: obtaining an element, via a protocol data unit (PDU) associated with a second protocol layer, with information identifying a first set of one or more discarded protocol data units (PDUs) associated with a first protocol layer; obtaining a second set of one or more PDUs associated the first protocol layer; and processing the second set of PDUs by using the information obtained in the element.

Clause 12: The method of Clause 11, wherein at least one of: the first protocol layer comprises a packet data convergence protocol (PDCP) layer; or the second protocol layer comprises a medium access control (MAC) layer.

Clause 13: The method of any one of Clauses 11-12, wherein the information identifies one or more sequence numbers (SNs) of the first set of one or more discarded PDUs.

Clause 14: The method of any one of Clauses 11-13, wherein the information comprises a list or bitmap that identifies one or more sequence numbers (SNs) of the first set of one or more discarded PDUs.

Clause 15: The method of any one of Clauses 11-14, wherein the second set of PDUs have one or more sequence numbers (SNs) higher than one or more SNs of the discarded PDUs.

Clause 16: The method of Clause 15, wherein processing the second set of PDUs of the first protocol layer based on the information obtained in the element comprises: delivering the second set of PDUs to a third protocol layer independent of a reordering timer; and updating a window based on the one or more SNs of the second set of PDUs.

Clause 17: The method of any one of Clauses 11-16, wherein the element comprises a MAC control element (CE).

Clause 18: The method of Clause 17, wherein the MAC CE includes a type field indicating the MAC CE conveys information that identifies SNs of the one or more discarded PDUs.

Clause 19: The method of Clause 17, wherein the MAC CE is obtained with or after the second set of PDUs.

Clause 20: The method of any one of Clauses 11-19, further comprising obtaining signaling indicating use of the element to indicate discarded PDUs is activated.

Clause 21: An apparatus, comprising: at least one memory comprising executable instructions; and at least one processor configured to execute the executable instructions and cause the apparatus to perform a method in accordance with any combination of Clauses 1-20.

Clause 22: An apparatus, comprising means for performing a method in accordance with any combination of Clauses 1-20.

Clause 23: A non-transitory computer-readable medium comprising executable instructions that, when executed by at least one processor of an apparatus, cause the apparatus to perform a method in accordance with any combination of Clauses 1-2220

Clause 24: A computer program product embodied on a computer-readable storage medium comprising code for performing a method in accordance with any combination of Clauses 1-20.

Clause 25: A wireless node (e.g., a UE or network entity) comprising: at least one transceiver; at least one memory comprising executable instructions; and at least one processor configured to execute the executable instructions and cause the apparatus to perform a method in accordance with any combination of Clauses 1-10, wherein the at least one transceiver is configured to receive the first frame.

Clause 26: A wireless node (e.g., a UE or network entity) comprising: at least one transceiver; at least one memory comprising executable instructions; and at least one processor configured to execute the executable instructions and cause the apparatus to perform a method in accordance with any combination of Clauses 11-20, wherein the at least one transceiver is configured to receive the first frame.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

Means for generating, means for outputting, means for obtaining, means for delivering, means for updating, and means for processing may comprise one or more processors, such as one or more of the processors described above with reference to FIG. 12.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions and cause the apparatus to:
generate an element with information identifying a first set of one or more discarded protocol data units (PDUs) associated with a first protocol layer; and
output the element for transmission via a PDU associated with a second protocol layer.

2. The apparatus of claim 1, wherein at least one of:
the first protocol layer comprises a packet data convergence protocol (PDCP) layer; or
the second protocol layer comprises a medium access control (MAC) layer.

3. The apparatus of claim 1, wherein the information identifies one or more sequence numbers (SNs) of the first set of one or more discarded PDUs.

4. The apparatus of claim 1, wherein the information comprises a list or a bitmap that identifies one or more sequence numbers (SNs) of the first set of one or more discarded PDUs.

5. The apparatus of claim 1, wherein the element comprises a MAC control element (CE).

6. The apparatus of claim 5, wherein the one or more processors are further configured to execute the computer-executable instructions and cause the apparatus to, after outputting the MAC CE, output one or more PDUs with one or more SNs higher than one or more SNs of the one or more discarded PDUs.

7. The apparatus of claim 5, wherein the MAC CE includes a type field indicating the MAC CE conveys information that identifies one or more SNs of the one or more discarded PDUs.

8. The apparatus of claim 5, wherein the one or more processors are further configured to execute the computer-executable instructions and cause the apparatus to output a second set of one or more PDCP PDUs with or after outputting the MAC CE.

9. The apparatus of claim 1, wherein the one or more processors are further configured to execute the computer-executable instructions and cause the apparatus to output signaling indicating use of the element to indicate discarded PDUs is activated, when one or more conditions are met.

10. The apparatus of claim 9, wherein the one or more conditions involve at least one of:
detection of discarded PDUs;
traffic congestion; or
a quality of service (QOS) policy.

11. The apparatus of claim 1, further comprising at least one transceiver configured to transmit the element, wherein the apparatus is configured as a user equipment (UE) or a network entity.

12. An apparatus for wireless communication, comprising:
at least one memory comprising computer-executable instructions; and
one or more processors configured to execute the computer-executable instructions and cause the apparatus to:
obtain an element, via a protocol data unit (PDU) associated with a second protocol layer, with information identifying a first set of one or more discarded protocol data units (PDUs) associated with a first protocol layer;
obtain a second set of one or more PDUs associated the first protocol layer; and
process the second set of PDUs by using the information obtained in the element.

13. The apparatus of claim 12, wherein at least one of:
the first protocol layer comprises a packet data convergence protocol (PDCP) layer; or
the second protocol layer comprises a medium access control (MAC) layer.

14. The apparatus of claim 12, wherein the information identifies one or more sequence numbers (SNs) of the first set of one or more discarded PDUs.

15. The apparatus of claim 12, wherein the information comprises a list or bitmap that identifies one or more sequence numbers (SNs) of the first set of one or more discarded PDUs.

16. The apparatus of claim 12, wherein the second set of PDUs have one or more sequence numbers (SNs) higher than one or more SNs of the discarded PDUs.

17. The apparatus of claim 16, wherein in order to process the second set of PDUs of the first protocol layer based on the information obtained in the element, the one or more processors are further configured to execute the computer-executable instructions and cause the apparatus to:
deliver the second set of PDUs to a third protocol layer independent of a reordering timer; and
update a window based on the one or more SNs of the second set of PDUs.

18. The apparatus of claim 12, wherein the element comprises a MAC control element (CE).

19. The apparatus of claim 18, wherein the MAC CE includes a type field indicating the MAC CE conveys information that identifies SNs of the one or more discarded PDUs.

20. A method for wireless communications at a first wireless node, comprising:
generating an element with information identifying a first set of one or more discarded protocol data units (PDUs) associated with a first protocol layer; and
outputting the element for transmission via a PDU associated with a second protocol layer.
